(19) United States
(12) Patent Application Publication
(10) Pub. No.: US 2016/0047947 A1
(43) Pub. Date: Feb. 18, 2016

(54) CONCAVE AND CONVEX SURFACE OBJECT AND METHOD OF FABRICATING SAME

(71) Applicant: Panasonic Intellectual Property Management Co., Ltd., Osaka (JP)

(72) Inventors: Makoto UMETANI, Osaka (JP); Akira KAWASE, Osaka (JP); Akinobu MIYAZAKI, Osaka (JP); Chiharu MAETA, Osaka (JP)

(21) Appl. No.: 14/832,112

(22) Filed: Aug. 21, 2015

Related U.S. Application Data
(63) Continuation of application No. PCT/JP2014/005087, filed on Oct. 6, 2014.

(30) Foreign Application Priority Data
Oct. 17, 2013 (JP) 2013-216236

(51) Int. Cl. G02B 1/118; G02B 1/111

(52) U.S. Cl. CPC G02B 1/118; G02B 1/111

(57) ABSTRACT

A lens has an SWS on its surface. The SWS has base and a plurality of convex portions arranged on a surface of the base, and is made of a mixed material obtained by dispersing inorganic fine particles in an organic material. The average refractive index of the SWS varies from the refractive index of air to the refractive index of the base, from a tip of each of the convex portions to the base. The inorganic fine particles exist more in a surface portion of each of the convex portions than in an inner portion of the convex portion.

### CROSS-REFERENCE TO RELATED APPLICATIONS

This is a continuation of International Application No. PCT/JP2014/005087 filed on Oct. 6, 2014, which claims priority to Japanese Patent Application No. 2013-216236 filed on Oct. 17, 2013. The entire disclosures of these applications are incorporated by reference herein.

### BACKGROUND OF THE INVENTION

The techniques disclosed herein relate to concave and convex surface objects like micro cone array objects, and methods for fabricating the concave and convex surface objects.

Concave and convex surface objects have been known and are utilized in various technical fields, and there are various examples of application. For example, Patent Document 1 (Japanese Unexamined Patent Publication No. 2009-128540), Patent Document 2 (Japanese Unexamined Patent Publication No. 2006-243633), and Patent Document 3 (Japanese Unexamined Patent Publication No. 2006-235195) disclose antireflection structures having, on their surfaces, fine concave and convex structures for reducing reflection of light.

In Patent Document 1, a resist layer is formed on a surface of a substrate made of, e.g., glass, metal, ceramics or resin, and a pattern is formed on the resist layer by lithography using electron beam or proton beam, thereby obtaining a mask. Using this mask, etching is performed to form a concave and convex structure in the surface of the substrate.

In Patent Document 2, a resist layer is formed on a surface of a glass substrate, and hologram exposure and development method by two-beam interference is performed on the resist layer, thereby obtaining a mask with fine patterns. Using this mask, etching is performed to form a concave and convex structure in the surface of the glass substrate.

In Patent Document 3, X-ray masks are placed on an optical component made of a sensitive material to X-ray, with a predetermined space between themselves. The optical component is irradiated with X-rays through the X-ray masks, thereby forming a concave and convex structure in the surface of the optical component.

Patent Document 4 (Japanese Unexamined Patent Publication No. 2000-167955) and Patent Document 5 (Japanese Translation of PCT International Application No. 2000/50232) disclose concave and convex surface objects having water-repellent.

Patent Document 6 (Japanese Unexamined Patent Publication No. 2005-290402) discloses a capacitor with an increased surface area due to a fine concave and convex structure formed in its surface.

Patent Document 7 (Japanese Unexamined Patent Publication No. S62-83641) discloses an example in which a concave and convex surface object is used as a sensor.

### SUMMARY OF THE INVENTION

As a matter of course, it is desired that the concave and convex structures be easily formed on any types of concave and convex surface objects.

In view of the foregoing background, the techniques disclosed herein provide concave and convex surface objects that can be easily fabricated.

The techniques disclosed herein are intended for a concave and convex surface object having a concave and convex structure on its surface. The concave and convex structure has a base and a plurality of convex portions arranged on a surface of the base, and is made of a mixed material obtained by dispersing inorganic fine particles in an organic material, an average refractive index of the concave and convex structure varies from a refractive index of air to a refractive index of the base, from a tip of each of the convex portions to the base, and the inorganic fine particles exist more in a portion near a surface of each of the convex portions than in an inner portion of the convex portion.

The techniques disclosed herein are intended for a concave and convex surface object having a concave and convex structure on its surface. The concave and convex structure has a base and a plurality of convex portions arranged on a surface of the base, and is made of a mixed material of inorganic fine particles and an organic material, and a volume ratio of the inorganic fine particles in the convex portions is higher than a volume ratio of the inorganic fine particles in the base.

The techniques disclosed herein are intended for a method of fabricating a concave and convex surface object having a concave and convex structure on its surface. The method of fabricating the concave and convex surface object includes the steps of: forming a mixture layer made of a mixed material obtained by dispersing inorganic fine particles in an organic material; and selectively removing the organic material in the mixture layer, thereby forming a base and a plurality of convex portions of which an average refractive index varies from a refractive index of air to a refractive index of the base, from a tip of each of the convex portions to the base, and making each of the convex portions contain the inorganic fine particles more in a portion near a surface of each of the convex portions than in a portion near the base.

According to the above concave and convex surface object, it is possible to provide a concave and convex surface object which can be easily fabricated.

According to the above method of fabricating the concave and convex surface object, it is possible to easily fabricate a concave and convex surface object.

### BRIEF DESCRIPTION OF THE DRAWINGS

FIG. 1 is a cross-sectional view of a lens cut along a plane parallel to an optical axis.

FIG. 2 is an enlarged cross-sectional view of an antireflection layer.

FIGS. 3(A)-3(D) illustrate steps of fabricating a lens. FIG. 3(A) is a step of preparing a lens body. FIG. 3(B) is a step of forming a mixture layer. FIG. 3(C) is a step of forming convex portions. FIG. 3(D) illustrates the lens having the convex portions in its surface.

FIG. 4 is a schematic view of a camera.

FIGS. 5(A) and 5(B) show SEM images of a cross section of a concave and convex surface object of a first example. FIG. 5(A) is a cross-sectional view of a large area. FIG. 5(B) is an enlarged cross-sectional view.

FIGS. 6(A) and 6(B) show results of measurement of surface compositions of the concave and convex surface object of the first example. FIG. 6(A) shows the surface composition of an SWS. FIG. 6(B) shows the surface composition of a base.

FIG. 7 shows a result of measurement of reflectances of the SWS of the first example.

FIGS. 8(A) and 8(B) show SEM images of a cross section of a concave and convex surface object of a second example. FIG. 8(A) is a cross-sectional view of a large area. FIG. 8(B) is an enlarged cross-sectional view.

FIGS. 9(A) and 9(B) show results of measurement of surface compositions of the concave and convex surface object of the second example. FIG. 9(A) shows the surface composition of an SWS. FIG. 9(B) shows the surface composition of a base.

FIGS. 10(A) and 10(B) show results of measurement of reflectances of the SWS of the second example.

FIGS. 11(A) and 11(B) show results of measurement of surface compositions of a concave and convex surface object of a third example. FIG. 11(A) shows the surface composition of the concave and convex structure. FIG. 11(B) shows the surface composition of a base.

FIG. 12 shows results of measurement of reflectances of the concave and convex structure of the third example.

FIG. 13 shows results of simulation of the reflectances of the concave and convex structure of the third example.

### DETAILED DESCRIPTION OF THE INVENTION

Example embodiments will be described in detail below, based on the drawings.

[1. General Structure of Lens]

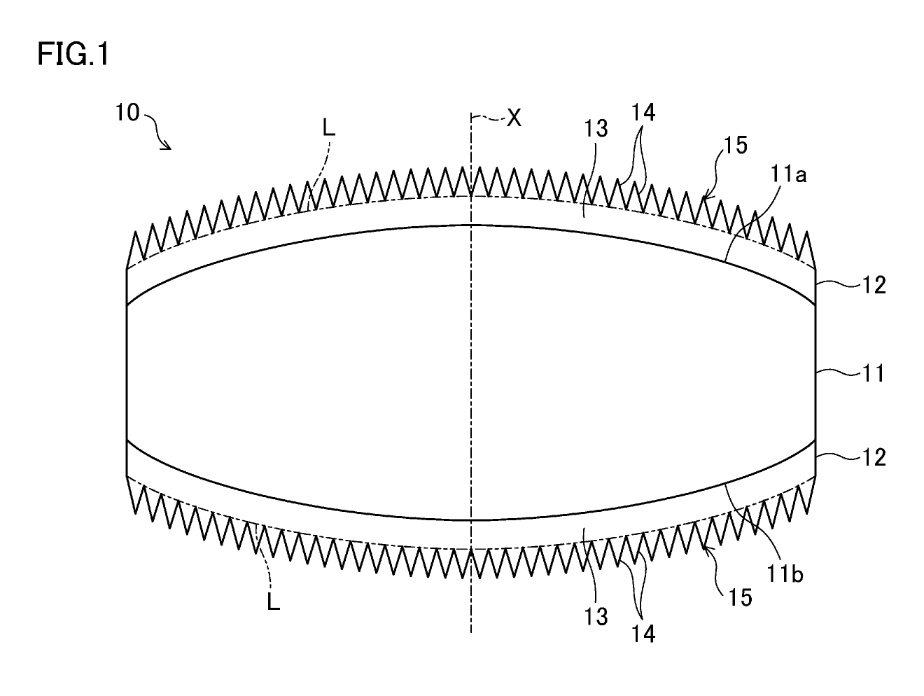

FIG. 1 illustrates a cross-sectional view of a lens 10 cut along a plane parallel to an optical axis X.

The lens 10 has a lens body 11 and antireflection layers 12, 12 provided on both surfaces of the lens body 11. The lens 10 is a biconvex lens. The both surfaces of the lens 10 are optical functional surfaces (also referred to as optical effective surfaces). The lens 10 is an example of a concave and convex surface object.

The lens body 11 forms a basic structure of the lens 10. That is, the lens body 11 is biconvex. Surfaces 11a, 11b of the lens body 11 are formed to have shapes necessary for achieving optical properties required of the lens 10. The surfaces 11a, 11b are smooth, curved surfaces. For example, the surfaces 11a, 11b can be a spherical surface, an aspherical surface, or a free-form surface. The surfaces 11a, 11b may be a flat surface. The lens body 11 is a resin-molded product produced by injection molding. The lens body 11 is not limited to the resin-molded product, and may be made of glass.

Since the basic configuration of the antireflection layer 12 on the surface 11a and the basic configuration of the antireflection layer 12 on the surface 11b are the same, the antireflection layer 12 on the surface 11a will be described below.

The antireflection layer 12 has an antireflection structure (i.e., a sub wavelength structure (SWS)) 15 which reduces reflection of light. The SWS 15 is an example of a concave and convex structure. The SWS 15 has a base 13 and a plurality of convex portions 14 arranged on the base 13.

The base 13 is a fundamental part of the antireflection layer 12, and is in close contact with the surface 11a of the lens body 11.

The convex portions 14 are arranged with a pitch smaller than or equal to a predetermined pitch (an interval). The predetermined pitch is set to be shorter than a wavelength (hereinafter referred to as a “target wavelength”) of light (hereinafter referred to as “target light”) of which the reflection is intended to be reduced by the antireflection layer 12. That is, the plurality of convex portions 14 reduce reflection at least of light whose wavelength is longer than or equal to the predetermined pitch. Each of the convex portions 14 is tapered, e.g., in a conical shape. The convex portions 14 extend substantially parallel to the optical axis X of the lens 10. However, some of the convex portions 14 may not extend straight along the optical axis X, but may extend obliquely with respect to the optical axis X, may be curved with respect to the optical axis X, or may be bent.

That is, in the SWS 15, an apparent refractive index gradually changes from the air (refractive index n0=1) to the lens material (refractive index n1>1), thereby reducing surface reflection. In other words, the average refractive index of the SWS 15 varies from the refractive index of air to the refractive index of the base 13, from a tip of each of the convex portions 14 to the base 13.

[2. Detail Structure of Convex Portions]

The antireflection layer 12 has the plurality of arranged convex portions 14, and therefore has a plurality of concave portions surrounded by the convex portions 14 between the plurality of the convex portions 14. An imaginary plane formed by connecting bottom portions (the lowest portions) of the plurality of concave portions is referred to as a base plane L. The base plane L is approximately parallel to the surface 11 a of the lens body 11.

The pitch of the convex portions 14 is a distance between the vertexes of adjacent convex portions 14 in a direction parallel to a plane orthogonal to the optical axis X. The height of the convex portion 14 in the optical axis direction is a distance from the vertex of the convex portion 14 to the base plane L in the optical axis direction.

When the lens 10 is used in an imaging optical system, the target light is visible light. Since in that case the target wavelength is 400 nm to 700 nm, the pitch of the convex portions 14 is preferably 400 nm or less.

A reflectance of the SWS 15 with respect to the target light (e.g., visible light) is preferably 1% or less. In order to obtain improved antireflection properties, the height of the convex portion 14 is preferably 0.4 times or more of the target wavelength. If the target light is visible light, the height of the convex portion 14 is preferably 280 nm or more. More preferably, the height of the convex portion 14 is 500 nm.

In order to avoid diffracted light, the pitch of the convex portions 14 is preferably less than or equal to a quotient obtained by dividing the target wavelength by the refractive index of the lens 10. If the target wavelength is visible light, and the refractive index of the lens 10 is 1.5, the pitch of the convex portions 14 is preferably 266 nm or less.

It is preferable that the optical functional surface of the lens 10 has a relatively low reflectance and a relatively high transmittance. For example, when the pitch of the convex portions 14 is 230 nm, and the height of the convex portions 14 is 350 nm, the reflectance in the entire range of visible light can be 0.1 to 0.2% or less, so that it is possible to obtain satisfactory antireflection properties.

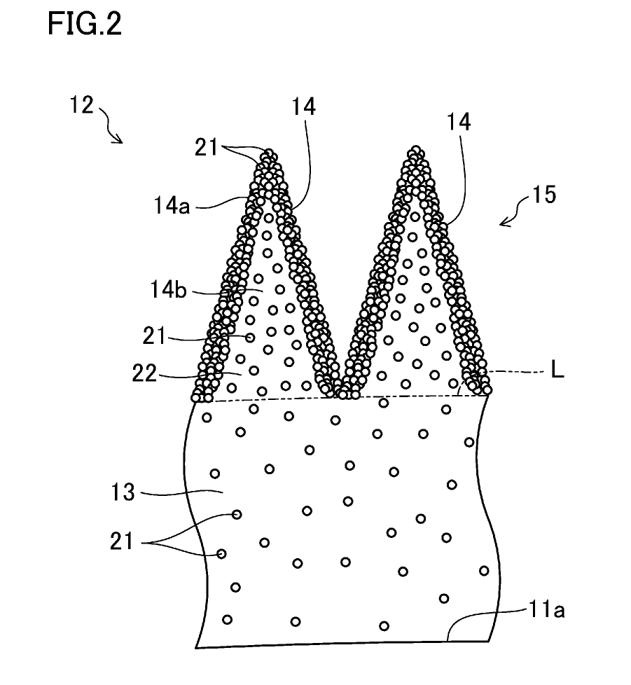

FIG. 2 illustrates an enlarged cross-sectional view of the antireflection layer 12. The antireflection layer 12 is made of a mixed material of inorganic fine particles 21 and an organic material 22.

The inorganic fine particles 21 are made of metal, oxide, nitride, carbide, oxynitride, or various types of salt. For example, the inorganic fine particles 21 include, as its main component, at least one selected from a group of zinc oxide (ZnO), silicon dioxide (SiO₂), smectite, bentonite, calcium carbonate, magnesium carbonate, alumina, montmorillonite, diatomaceous earth, magnesium oxide, titanium oxide, magnesium hydroxide, aluminum hydroxide, glass bead, barium sulfate, gypsum, calcium silicate, sericite activated clay, indium tin oxide (ITO), indium phosphate, and silicon oxynitride (SiON). Particularly in the case where the inorganic fine particles are used for optical devices which transmit light, such as a lens, the materials for the inorganic fine particles need to have a satisfactory transmittance. Thus, zinc oxide and silicon dioxide are favorable. Materials etched less preferentially than the organic material 22 (i.e., the organic material 22 is etched more preferentially than the inorganic fine particles 21) in relation to the type of the organic material 22 and etching conditions, are preferred as the inorganic fine particles 21.

The mean particle diameter of the inorganic fine particles 21 is preferably 50 nm or less. The inorganic fine particles 21 are easily agglomerated if the mean particle diameter of the inorganic fine particles 21 is 50 nm or less. Thus, when the organic material 22 are selectively etched by a fabrication method that will be described below, the inorganic fine particles 21 are agglomerated and the convex portions 14 are easily formed due to the agglomeration. Further, the particle diameter of the inorganic fine particles 21 affects the width and the pitch of the convex portions 14. That is, the smaller the particle diameter of the inorganic fine particles 21 is, the smaller the width and the pitch of the convex portions 14 become. The convex portions 14 whose width and pitch are small can be formed if the mean particle diameter of the inorganic fine particles 21 is 50 nm or less.

The term “mean particle diameter” as used herein means a number average diameter. The number average diameter is measured by using a transmission electron microscope (TEM) observation image. The diameter of a circle having the same area as that of an image of a fine particle in the TEM observation image is regarded as the particle diameter of the image of the fine particle. The particle diameter of a primary particle, not a secondary particle, is used. The number average diameter is calculated by, for example, a known technique of statistical processing of image data. It is preferred that the number of images of the fine particles to be used in the statistical processing (the number of data for statistical processing) is as large as possible. In terms of reproducibility, the number of images of the fine particles randomly selected is 50 or more. Preferably, the number of images of the fine particles used for the statistical processing may be 80 or more, or more preferably 100 or more.

The content of the inorganic fine particles 21 is not particularly limited. However, if ZnO or SiO₂ is used as the inorganic fine particles 21, the content of the inorganic fine particles 21 is preferably 2 volume parts or more and 16 volume parts or less, with respect to 100 volume parts of the organic material. By setting the content of the inorganic fine particles 21 to 2 volume parts or more, it is possible to form concave and convex structures, which have properties of reducing reflection, by etching. By setting the content of the inorganic fine particles 21 to 16 volume parts or less, it is possible to reduce a decline of a transmittance caused by scattering to a practically allowable level. More preferably, the content of the inorganic fine particles 21 is 3 volume parts or more and 12 volume parts or less, with respect to 100 volume parts of the organic material.

In the case where the organic material 22 is used for optical devices, a resin that is highly transparent to light can be selected from resins, such as a thermoplastic resin, a thermosetting resin, and an energy ray-curing resin, for use as the organic material 22. For example, an acrylic acid-based resin, a methacrylic acid-based resin, an epoxy-based resin, a polyester-based resin, a polystyrene-based resin, a polyolefin-based resin, a polyamide-based resin, a polyimide-base resin, polyvinyl alcohol, a butyral resin, a vinyl acetate resin, or a alicyclic polyolefin resin may be used as the organic material 22. Other examples of the organic material 22 may include engineering plastic, such as polycarbonates, liquid crystal polymers, polyphenylene ether, polysulfone, polyether sulfone, polyallylates, and amorphous polyolefin. Moreover, a silicone resin and others can be used as the organic material 22. Further, a mixture or a copolymer of the above resins may be used, and resins modified from these resins may also be used. For example, cycloolefin resin, epoxy resin, or polyester acrylate (polyfunctional) may be used as the organic material 22. Preferably, the organic material 22 is a material that is etched preferentially, compared to the inorganic fine particles 21, in relation to the type of the inorganic fine particles 21 and the etching conditions. In particular, polyester acrylate (polyfunctional) is favorable since it is an energy ray-curing resin and has good translucency. However, the organic material 22 is not specifically limited thereto, and the above disclosure is not intended to limit the subject matter of the claims.

More specifically, the convex portion 14 contains a plurality of inorganic fine particles 21. The height of the convex portion 14 is at least twice or more, preferably ten times or more, and more preferably a hundred times or more of the mean particle diameter of the inorganic fine particles 21. The width of the convex portion 14 is at least twice or more, preferably ten times or more, and more preferably twenty times or more of the mean particle diameter of the inorganic fine particles 21.

The inorganic fine particles 21 are agglomerated on the surface of the convex portion 14. That is, the inorganic fine particles 21 are in contact with one another. On the other hand, in the convex portion 14, the inorganic fine particles 21 are dispersed in the organic material 22. This means that the inorganic fine particles 21 exist more in a portion near the surface (hereinafter referred to as a “surface portion”) of the convex portion 14, than in an inner portion 14b of the convex portion 14. In the convex portion 14, the density of the inorganic fine particles 21 increases with a decrease in the distance toward the surface. The volume ratio of the inorganic fine particles 21 (that is, a ratio of the volume of the inorganic fine particles 21 in a unit volume with respect to the entire unit volume) in the convex portion 14 increases with a decrease in the distance toward the surface. For example, the volume ratio of the inorganic fine particles 21 per unit volume (for example, per cube whose length of an edge is 100 nm, and preferably 50 nm) in the surface portion (a portion including the surface) of the convex portion 14 is higher than that in the inner portion 14b of the convex portion 14. Alternatively, in a cross section of the antireflection layer 12, the area ratio of the inorganic fine particles 21 (that is, a ratio of the area of the inorganic fine particles 21 in a unit area with respect to the entire unit area) per unit area (for example, per square whose length of a side is 100 nm, and preferably 50 nm) in the surface portion 14a of the convex portion 14 is higher than that in the inner portion 14b of the convex portion 14.

In the base 13, the inorganic fine particles 21 are dispersed in the organic material 22. For this reason, the volume ratio of the inorganic fine particles 21 per unit volume (for example, per cube whose length of an edge is 100 nm, and preferably 50 nm, and which includes at least part of the surface portion 14a) in the convex portion 14 is higher than the volume ratio of the inorganic fine particles 21 per unit volume in the base 13. Alternatively, in a cross section of the antireflection layer 12, the area ratio of the inorganic fine particles 21 per unit area (for example, per square whose length of a side is 100 nm, and preferably 50 nm, and which includes at least part of the surface portion 14a) in the convex portion 14 is higher than the area ratio of the inorganic fine particles 21 per unit area in the base 13.

Such a convex portion 14 which has more inorganic fine particles 21 on its surface than in the inner portion 14b and the base 13 can be easily fabricated by a fabrication method which will be described below.

[3. Fabrication Method]

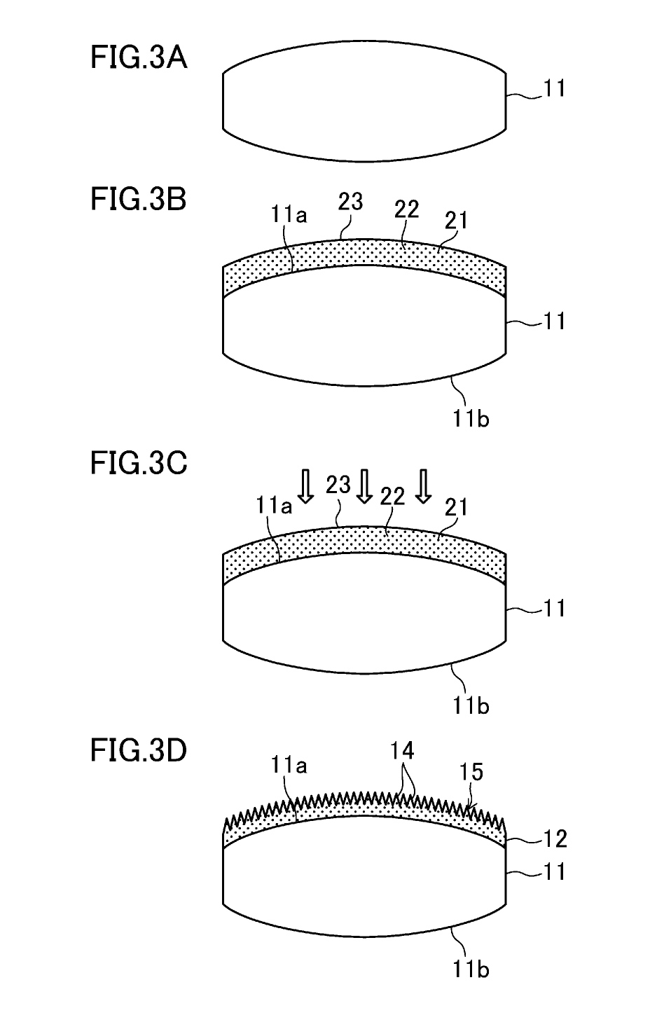

A method of fabricating the lens 10 will be described below. FIGS. 3(A)-3(D) illustrate the steps of fabricating the lens 10.

First, a lens body 11 is prepared as illustrated in FIG. 3(A). The lens body 11 is formed by injection molding, etc.

Next, as illustrated in FIG. 3(B), a mixture layer 23 made of a mixed material in which the inorganic fine particles 21 are dispersed in the organic material 22 is formed on the surface 11 a of the lens body 11 (a step of forming a mixture layer). For example, the mixed material before solidification, in which the inorganic fine particles 21 are dispersed in the organic material 22, is applied to the surface 11 a of the lens body 11 by dipping or spin coating. The applied mixed material is solidified, thereby forming the mixture layer 23 on the surface 11a.

It is preferred that the mean particle diameter of the inorganic fine particles 21 is 50 nm or less. Setting the mean particle diameter of the inorganic fine particles 21 to 50 nm or less enables the inorganic fine particles 21 to be easily agglomerated in an etching process that will be described later. The term “mean particle diameter” as used herein does not have to be the number average diameter mentioned above, but may be a particle diameter (hereinafter referred to as “d50”) at 50% integrated value in a particle diameter distribution measured with a laser diffraction/scattering particle size distribution analyzer. The particle diameter at “50% integrated value” means the diameter of the particle at the time when the number of particles counted has reached 50% of the total number of the particles in the course of counting the number of particles starting from small-sized particles. After the fabrication of the concave and convex surface object, that is, in the stage after the formation of the convex portion 14, it is difficult to measure the particle diameter distribution of the inorganic fine particles 21, using the laser diffraction/scattering particle size distribution analyzer. It is therefore preferred that the number average diameter is determined from a TEM observation image. On the other hand, in the stage before fabrication of the concave and convex surface object, it is comparatively easy to measure the particle diameter distribution of the inorganic fine particles 21, using the laser diffraction/scattering particle size distribution analyzer. Thus, d50 can be the mean particle diameter.

The thickness of the mixture layer 23 is at least twice or more, preferably ten times or more, and more preferably a hundred times or more of the mean particle diameter of the inorganic fine particles 21. By setting the thickness of the mixture layer 23 to at least twice or more of the mean particle diameter of the inorganic fine particles 21, it becomes easier to form the convex portion 14 containing the plurality of inorganic fine particles 21. Moreover, by setting the thickness of the mixture layer 23 to ten times or more, and further to a hundred or more of the mean particle diameter of the inorganic fine particles 21, it becomes easier to form higher convex portions 14. The thickness of the mixture layer 23 can be 1 to 50 μm, for example.

Subsequently, as illustrated in FIG. 3(C), the mixture layer 23 is etched (a step of forming a convex portion). The organic material 22 is selectively etched. That is, an etching speed of the organic material 22 is greater than an etching speed of the inorganic fine particles 21. As a result, the organic material 22 is preferentially etched and removed. The inorganic fine particles 21 are agglomerated as the organic material 22 is etched. The etching of the organic material 22 proceeds in a direction of the thickness of the mixture layer 23.

As a result, the convex portions 14 are formed as the etching proceeds, as illustrated in FIG. 3(D). Since the amount of removal of the organic material 22 increases with a decrease in the distance to the tip side of the convex portion 14, the volume ratio of the inorganic fine particles 21 increases with a decrease in the distance to the tip side of the convex portion 14. Moreover, the convex portion 14 is formed to have a tapered shape. Such convex portions 14 are formed all over the mixture layer 23, and the convex portions 14 as a whole form the SWS 15.

In the convex portion 14, the organic material 22 is removed more on its surface side than in its inner side. This means that the volume ratio of the inorganic fine particles 21 is greater on its surface side. As a result, a component ratio between the inorganic fine particles 21 and the organic material 22 differs between the surface portion 14a and the inner portion 14b of the convex portion 14. That is, the volume ratio of the inorganic fine particles 21 is greater in the surface portion 14a of the convex portion 14 than in the inner portion 14b of the convex portion 14.

A mixture layer 23 is also formed on the other surface 11b of the lens body 11, and is etched, thereby forming the SWS 15.

The antireflection layers 12 are formed on both surfaces 11a, 11b of the lens body 11 in this manner. As a result, the lens 10 is completed.

The width, the height, and the pitch of the convex portions 14 can be adjusted according to the types of the inorganic fine particles 21, the types of the organic material 22, and etching conditions (etching speed).

For example, if the type of the inorganic fine particles 21 and the type of the organic material 22 are fixed, the pitch of the convex portions 14 changes due to at least the particle diameter of the inorganic fine particles 21 and the content ratio of the inorganic fine particles 21 with respect to the organic material 22. That is, the larger the particle diameter of the inorganic fine particles 21 is, and the lower the content ratio of the inorganic fine particles 21 is, the greater the pitch of the convex portions 14 becomes.

If the pitch of the convex portion 14 is increased, the width of the convex portion 14 is also increased. Further, the width of a tip portion of the convex portion 14 depends at least on the particle diameter of the inorganic fine particles 21. That is, the smaller the particle diameter of the inorganic fine particles 21 is, the narrower the width of the tip portion of the convex portion 14 becomes.

If the type of the inorganic fine particles 21 and the type of the organic material 22 are fixed, the height of the convex portion 14 changes due to at least the etching condition, e.g., etching time. That is, the longer the etching time is, the deeper the depth of the etching becomes. This means that the convex portion 14 has an increased height. Since the height of the convex portion 14 depends on a degree of etching as described above, the height of the convex portion 14 is changed not only by the etching condition, but also by how easily the inorganic fine particles 21 and the organic material 22 are etched.

[4. Camera]

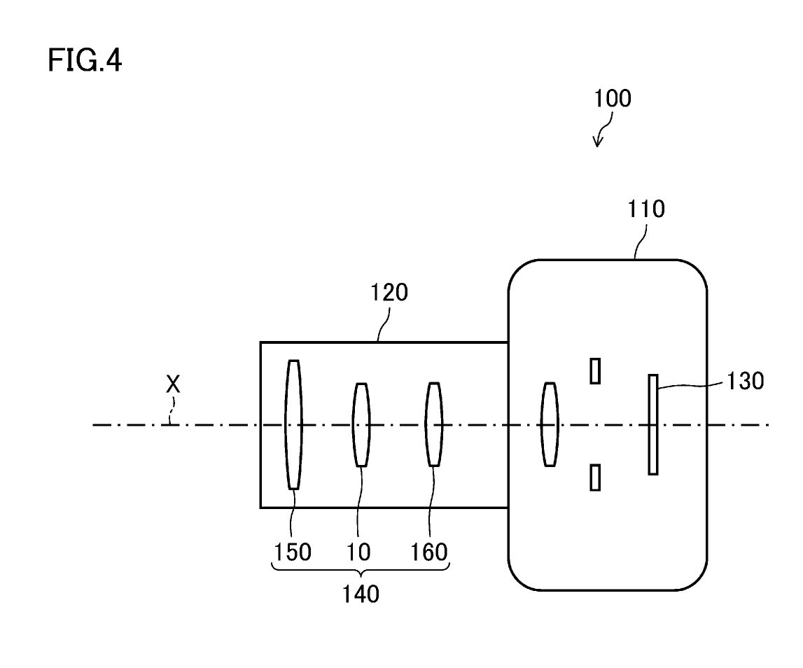

Now, a camera 100 having the lens 10 will be described. FIG. 4 is a schematic view of the camera 100.

The camera 100 has a camera body 110 and an interchangeable lens 120 attached to the camera body 110. The camera 100 is an example of an imaging device.

The camera body 110 has an imaging device 130.

The interchangeable lens 120 is configured to be attachable to the camera body 110. The interchangeable lens 120 is, for example, a telephoto zoom lens. The interchangeable lens 120 has an imaging optical system 140 for focusing a light bundle on the imaging element 130 of the camera body 110. The imaging optical system 140 includes the lens 10 and refracting lenses 150 and 160. The lens 10 serves as a lens element.

[5. Advantages]

The lens 10 is provided with the SWS 15 on its surface. The SWS 15 has a base 13 and a plurality of convex portions 14 arranged on a surface of the base 13, and is made of a mixed material obtained by dispersing the inorganic fine particles 21 in the organic material 22. The average refractive index of the SWS 15 varies from the refractive index of air to the refractive index of the base 13, from a tip of each of the convex portions 14 to the base 13. The surface side portion 14a of each of the convex portions 14 includes the inorganic fine particles 21 more than the inner side portion 14b of the convex portion 14.

The convex portion 14 of the SWS 15 having the above configuration includes the inorganic fine particles 21 more in its surface portion 14a than in its inner portion 14b. Such a convex portion 14 can be easily obtained by forming the mixture layer 23 containing the inorganic fine particles 21 and the organic material 22, and selectively (preferentially) etching the organic material 22 in the mixture layer 23. According to this method, the organic material 22 is preferentially etched, and the inorganic fine particles 21 remain and become agglomerated, without forming a pattern and a mask which are required in conventional techniques. Therefore, the convex portions 14 are formed spontaneously as the etching proceeds. As a result, the lens 10 having the SWS 15 can be easily fabricated.

Increasing the etching time to increase the depth of the etching may be considered in order to increase an aspect ratio of the convex portion (height of the convex portion/width of the convex portion). However, in the case of conventional techniques where a single optical material (e.g., quartz glass) is simply etched, the tip portion of the convex portion is exposed to an etching species, such as an etching gas, for a longer period of time, which results in difficulty in obtaining a convex portion with a high aspect ratio. This means that special etching conditions where selectivity is significantly large are required in order to obtain a convex portion with a high aspect ratio. However, the selectivity cannot be increased with respect to some materials. Further, although it is possible to increase the aspect ratio by increasing the thickness of a mask in the case of forming a columnar structure, e.g., trench etching (such a structure has less antireflection properties), it is very difficult to increase the aspect ratio by simply increasing the thickness of the mask in the case of forming a conical convex portion. However, according to the method mentioned above, the organic material 22 is selectively (preferentially) etched. Thus, it is not only that the organic material 22 is etched, but also that the inorganic fine particles 21 remain and become agglomerated. As a result, the convex portions 14 with a high aspect ratio can be formed easier compared to the conventional fabrication methods.

The dimensions, such as the width, pitch and height, of the convex portion 14 can be easily adjusted by changing types (materials, dimensions, etc.) of the inorganic fine particles 21, types (materials, etc.) of the organic material 22, the content ratio of the inorganic fine particles 21 with respect to the organic material 22, and etching conditions (an etching speed, time, etc.).

Moreover, the lens 10 includes the SWS 15 on its surface. The SWS 15 has the base 13 and the plurality of convex portions 14 arranged on the surface of the base 13, and is made of a mixed material of the inorganic fine particles 21 and the organic material 22. The volume ratio of the inorganic fine particles 21 in the convex portions 14 is higher than the volume ratio of the inorganic fine particles 21 in the base 13.

The lens 10 having the above configuration has an improved light transmittance, with reduced light reflection. For improvement in a light transmittance, it is preferable to reduce the number of the inorganic fine particles 21. Light having entered in the SWS 15 through the plurality of convex portions 14 without being reflected can be transmitted through the base 13 at a high transmittance, since the volume ratio of the inorganic fine particles 21 in the base 13 is low.

The reflectance of the SWS 15 with respect to visible light is 1% or less.

That is, the plurality of convex portions 14 are used for the purpose of reducing light reflection. Note that the plurality of convex portions 14 are may also be used for increasing water repellency and increasing the area of the surface, for example.

The height of each of the convex portions 14 is 500 nm or more.

The above configuration has high light-reflection reduction properties at least with respect to visible light in the case where the plurality of convex portions 14 are used for the purpose of reducing light reflection.

The inorganic fine particles 21 are agglomerated on the surface of each of the convex portions 14.

In the above configuration, the inorganic fine particles 21 are in contact with one another on the surface of each of the convex portions 14. On the other hand, the inorganic fine particles 21 are dispersed in the organic material 22 in an inner portion of the convex portion 14 or in the base 13. Such an SWS 15 can be easily obtained by forming the mixture layer 23, and selectively etching the organic material 22 in the mixture layer 23.

The mean particle diameter of the inorganic fine particles 21 is preferably 50 nm or less.

Setting the mean particle diameter of the inorganic fine particles 21 to 50 nm or less enables the inorganic fine particles 21 to be easily agglomerated in an etching process. As a result, the convex portions 14 are easily formed. Here, the number average diameter or the particle diameter at 50% integrated value of the inorganic fine particles 21 may be 50 nm or less. If the particle diameter of the inorganic fine particles 21 is small, agglomeration easily occurs. The agglomeration of the inorganic fine particles 21 easily occurs in either case where the number average diameter of the inorganic fine particles 21 is 50 nm or less, or the particle diameter at 50% integrated value of the inorganic fine particles 21 is 50 nm or less. Preferably, both of the number average diameter and the particle diameter at 50% integrated value may be 50 nm or less.

Further, the method of fabricating the concave and convex surface object includes the steps of: forming a mixture layer 23 made of a mixed material obtained by dispersing inorganic fine particles 21 in an organic material 22; and forming, from the mixture layer 23, an SWS 15 having a base 13 and a plurality of convex portions 14 arranged on a surface of the base 13. The average refractive index of the SWS 15 varies from the refractive index of air to the refractive index of the base 13, from a tip of each of the convex portions 14 to the base 13. The step of forming the SWS 15 includes selectively removing the organic material 22 in the mixture layer 23, thereby forming the plurality of convex portions 14 each of which contains the inorganic fine particles 21 more in a portion near a surface of each of the convex portions 14 than in an inner portion of the convex portion 14.

According to this method, the organic material 22 is selectively removed from the mixture layer 23. Thus, the inorganic fine particles 21 remain and become agglomerated, and the convex portions 14 are formed spontaneously as the etching proceeds. As a result, the plurality of convex portions 14 can be easily formed. Further, the concave and convex structure can be easily formed in a surface of an object in any shape, as long as the mixture layer 23 can be provided (for example, a mixed material can be applied) on the surface, and the mixture layer 23 can be etched.

### Other Embodiments

The foregoing embodiment has been described as an example of the techniques disclosed in the present application. However, the techniques according to the present disclosure are not limited thereto, and are also applicable to those where modifications, substitutions, additions, and omissions are made. In addition, elements described in the above embodiment may be combined to provide a different embodiment. Further, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

The above embodiment may have the following configurations.

For example, the concave and convex surface object is not limited to the lens. The concave and convex surface object may be an optical element other than the lens. Further, the concave and convex surface object is not limited to the optical element. As mentioned earlier, the concave and convex surface object can be water-repellent objects, electronic components (e.g., capacitors), sensors, etc.

Further, the concave and convex structure is not limited to the SWS 15. The concave and convex structure may have a function other than reducing light reflection. For example, the concave and convex structure may be intended to repel water, increase a surface area, or detect a predetermined substance or gas.

Also in the case where the concave and convex structure is the SWS 15, the shape and the dimensions of the convex portion 14 can be arbitrarily determined according to the wavelength of light of which the reflection is intended to be reduced, and according to a degree of reflection reduction.

In the above embodiment, the lens body 11 and the antireflection layer 12 are separate elements, but they are not limited to such a configuration. For example, the lens body 11 may also be made of the mixed material of the inorganic fine particles 21 and the organic material 22, that is, the lens body 11 and the SWS 15 may be integrally formed. In that case, the lens body 11 forms the base of the concave and convex structure.

The technique of providing the mixture layer 23 is not limited to applying the mixed material. For example, the mixture layer 23 may be provided on the surface of the lens body 11 by filling a molding die with the mixed material, and further placing the lens body 11 in the molding die. That is, the mixture layer 23 may be formed by molding. If the mixture layer 23 is formed by molding, the thickness of the mixture layer 23 can be 50 to 200 μm, for example.

The technique of removing the organic material 22 is not limited to etching. For example, the organic material 22 may be removed by UV irradiation. The organic material 22 is selectively decomposed and removed by the UV irradiation, thereby forming, on the surface, the convex portions 14 where the inorganic fine particles 21 are agglomerated. As a result, the concave and convex structure having a plurality of convex portions 14 is formed.

### EXAMPLES

Examples of the concave and convex surface object and the method of fabricating the concave and convex surface object will be described below.

### First Example

In forming a concave and convex surface object according to the first example, polyester acrylate (polyfunctional) as the organic material in which SiO₂ fine particles as the inorganic fine particles were dispersed was used as the mixed material. In the mixed material, 10 weight % SiO₂ fine particles and 3 weight % dispersant were contained with respect to the whole weight. The particle diameter d50 of the SiO₂ fine particles was 8 nm, and the particle diameter d90 (a particle diameter obtained at the time when the number of particles counted has reached 90% of the total number of the particles in the course of counting the number of particles starting from small-sized particles) was 18 nm.

This mixed material was applied to the surface of the glass substrate by dipping, and thereafter cured by UV irradiation, thereby forming a mixture layer.

After that, the mixture layer was subjected to ECR (Electron Cyclotron Resonance) etching. Specifically, the etching was performed using a small-sized ECR ion shower system EIS-200ER manufactured by ELIONIX INC. Ionized gas was Ar gas. The acceleration voltage was 700 V. The etching time was 60 seconds. An SWS was formed in the surface of the glass substrate in this manner.

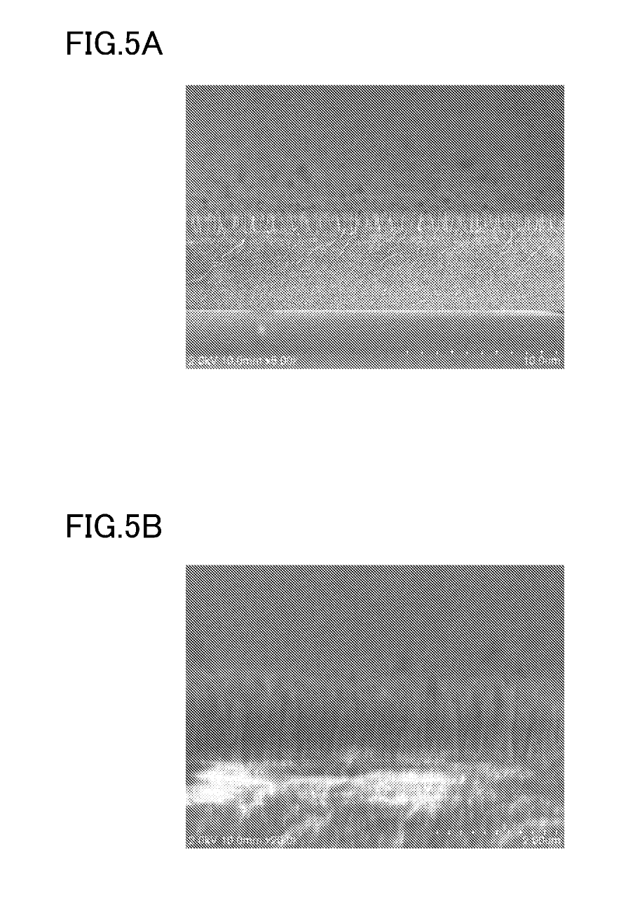

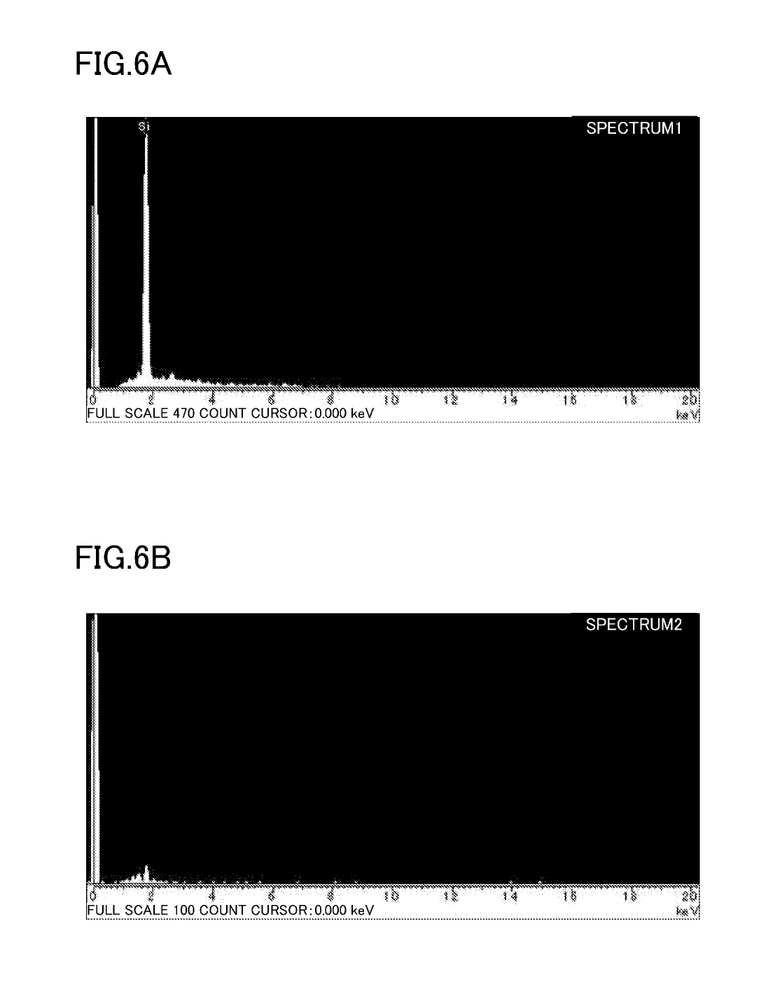

FIGS. 5(A) and 5(B) show SEM images of a cross section of the thus obtained concave and convex surface object. FIG. 5(B) is an enlarged cross section of the convex portions shown in FIG. 5(A). FIGS. 6(A) and 6(B) show results of measurement of surface compositions of the concave and convex surface object by energy dispersive x-ray spectroscopy (EDX). Measurement by EDX enables qualitative analysis of average elements existing from the surface to about 1 μm depth from the surface, and also enables composition analysis by intensity ratios of peaks corresponding to the respective elements. FIG. 6(A) shows a surface composition of the SWS. FIG. 6(B) shows a surface composition of the base. As the surface composition of the base, a surface composition of a base part in a cross section of the concave and convex surface object was measured.

As shown in FIG. 5(A), a plurality of convex portions are formed on the surface of the concave and convex surface object. Each of the convex portions is very thin and long, and has a high aspect ratio.

As shown in FIG. 5(B), the height of each of the convex portions was about 0.5 to 1.5 μm. Further, the surfaces of the convex portions look white in color, and inner portions of the convex portions look dark in color. The base on which the convex portions are formed also looks dark in color. In the SEM image, the more the inorganic fine particles exist, the whiter it looks, and the more the organic material exists, the darker it looks. That is, it is understood that the inorganic fine particles exist more in a portion near the surface of the convex portion, than in an inner portion of the convex portion. It is also understood that the volume ratio of the inorganic fine particles in the convex portions is higher than the volume ratio of the inorganic fine particles in the base.

Further, as shown in FIG. 6(A), the convex portions exhibit a high peak at around 1.8 keV. The peak at around 1.8 keV indicates existence of Si elements. That is, it is understood that the surface of the convex portion contains a lot of Si elements. On the other hand, as shown in FIG. 6(B), although the base exhibits a peak at around 1.8 keV, that peak is much lower than the peak exhibited by the convex portions. It is understood that the base contains less Si elements than the convex portions.

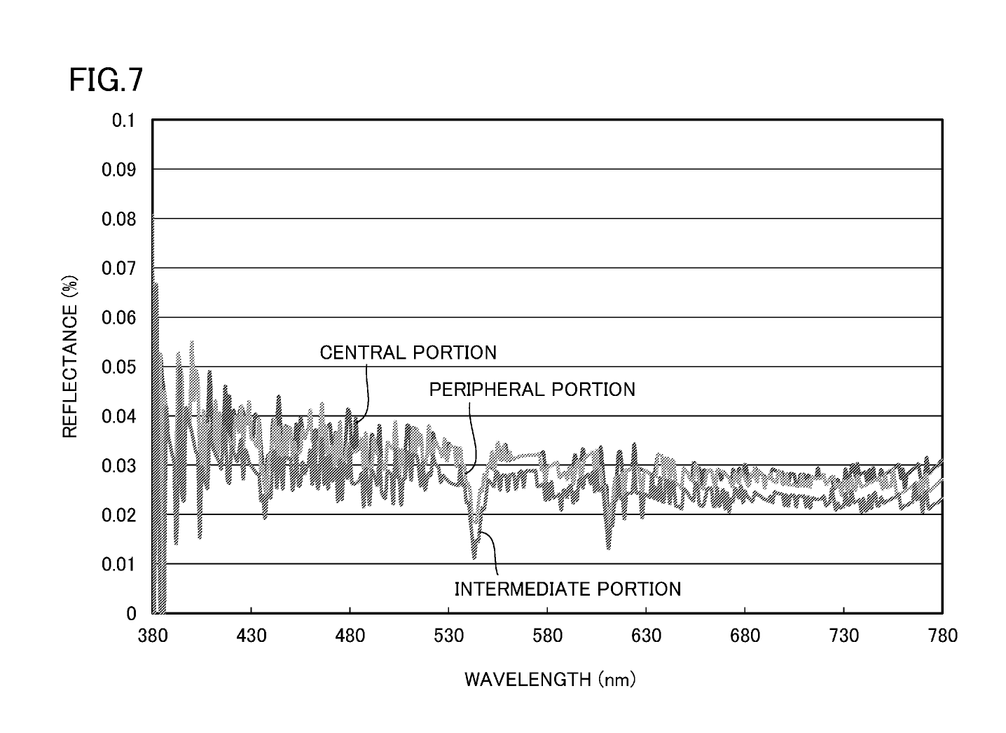

FIG. 7 shows a result of measurement of reflectances of the SWS formed by the above method. Reflectances of vertically-reflected light with respect to vertical incident light were measured using a device for measuring surface reflectance. The measurement was performed at three different portions on the SWS (i.e., a central portion, a peripheral portion (a portion that is 10 mm apart from the center), and an intermediate portion between the central portion and the peripheral portion). As shown in FIG. 7, reflection of light in a wide range of wavelengths is reduced. Specifically, the vertical reflectance of visible light (light at 400 to 700 nm) is 4.4 to 4.85% on the base, whereas the reflectance on the SWS is reduced to 0.05% or less.

### Second Example

In forming a concave and convex surface object according to the second example, polyester acrylate (polyfunctional) as the organic material in which ZnO fine particles as the inorganic fine particles were dispersed was used as the mixed material. In the mixed material, 20 weight % ZnO fine particles and 3 weight % dispersant were contained with respect to the whole weight. The particle diameter d50 of the ZnO fine particles was 8 nm, and the particle diameter d90 was 15 nm.

This mixed material was applied to the surface of the glass substrate by dipping, and thereafter cured by UV irradiation, thereby forming a mixture layer.

After that, the mixture layer was subjected to ECR etching. Specifically, the etching was performed using a small-sized ECR ion shower system EIS-200ER manufactured by ELIONIX INC. Ionized gas was Ar gas. The acceleration voltage was 700 V. The etching time was 40 seconds. An SWS was formed in the surface of the glass substrate in this manner.

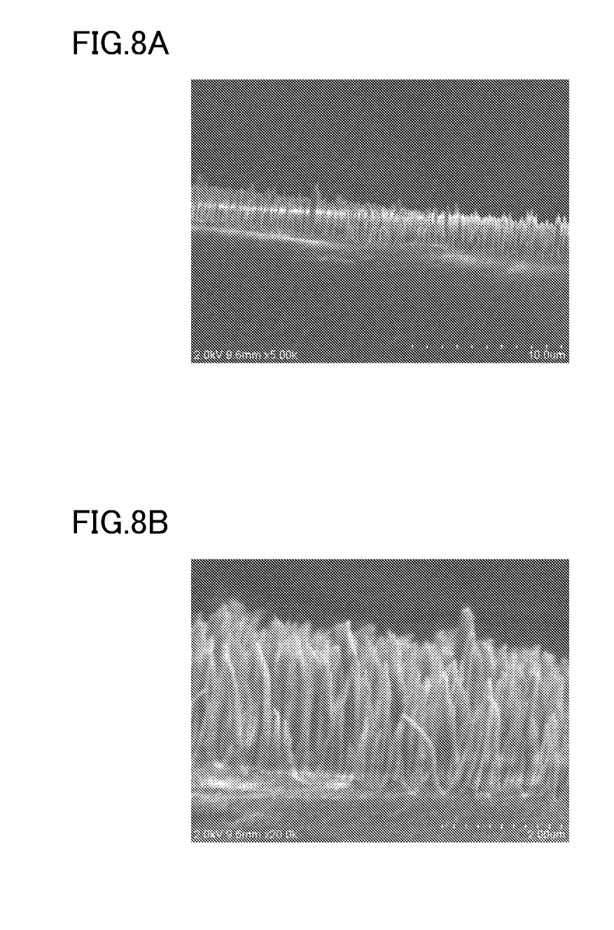

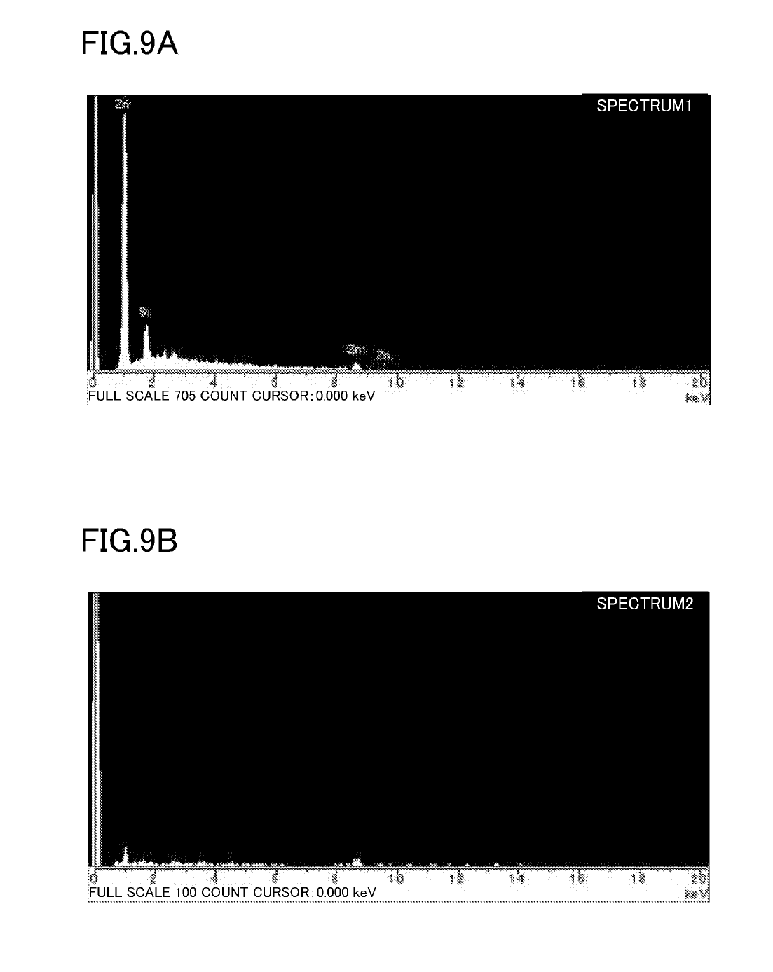

FIGS. 8(A) and 8(B) show SEM images of a cross section of the thus obtained concave and convex surface object. FIG. 8(B) is an enlarged cross section of the convex portions shown in FIG. 8(A). FIGS. 9(A) and 9(B) show results of measurement of surface compositions of the concave and convex surface object by EDX. FIG. 9(A) shows a surface composition of the SWS. FIG. 9(B) shows a surface composition of the base.

As shown in FIG. 8(A), a plurality of convex portions are formed on the surface of the glass substrate. Each of the convex portions is very thin and long, and has a high aspect ratio.

As shown in FIG. 8(B), the height of each of the convex portions was about 1 to 2 μm. Cross sections of the convex portions on the front side of the image can be partially observed. Specifically, cross sections of their bottom portions can be observed. In the cross sections, the surface of the convex portion looks white in color, and the inner portion of the convex portion looks dark in color. The base on which the convex portions are formed also looks dark in color. That is, it is understood that the inorganic fine particles exist more in a portion near the surface of the convex portion, than in the inner portion of the convex portion. It is also understood that the volume ratio of the inorganic fine particles in the convex portions is higher than the volume ratio of the inorganic fine particles in the base.

Further, as shown in FIG. 9(A), the convex portions exhibit a high peak at around 1 keV. The peak at around 1 keV indicates existence of Zn elements. That is, it is understood that the surface of the convex portion contains a lot of Zn elements. On the other hand, as shown in FIG. 9(B), although the base exhibits a peak at around 1 keV, that peak is much lower than the peak exhibited by the convex portions. It is understood that the base contains less Zn elements than the convex portions.

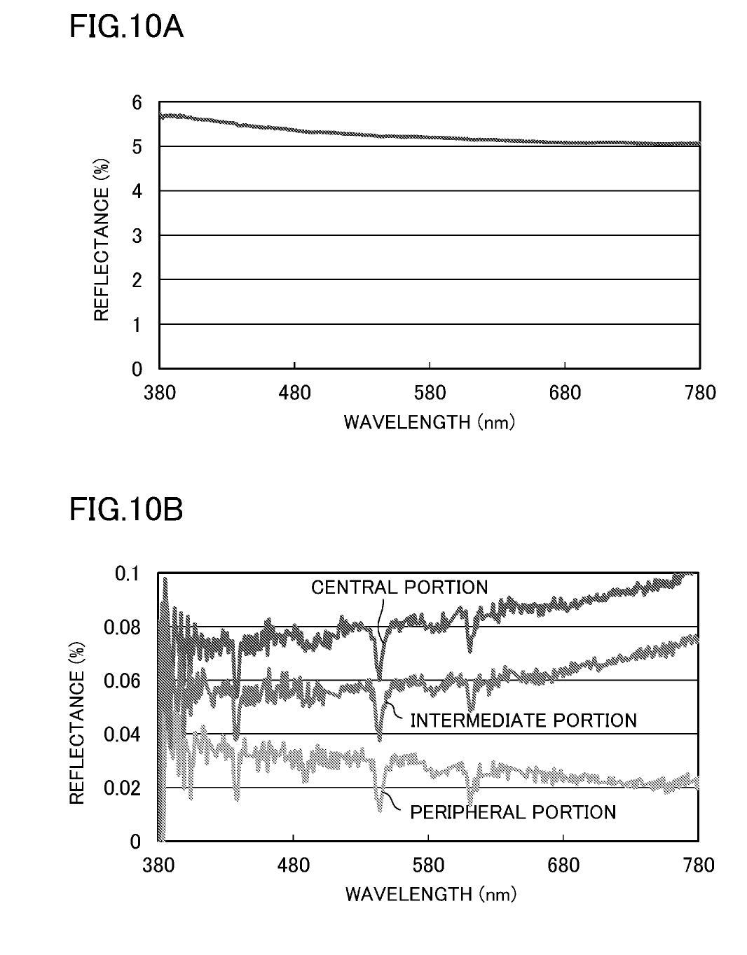

FIGS. 10(A) and 10(B) show results of measurement of reflectances of the SWS formed by the above method. Note that the SWS used for measurement of the reflectances is not formed on a glass substrate, but is formed on a substrate made of a black resin. FIG. 10(A) shows a result of measurement of the reflectances of the substrate made of the black resin on which the SWS is not formed. FIG. 10(B) shows a result of measurement of the reflectances of the substrate made of the black resin on which the SWS is formed. Reflectances of vertically-reflected light with respect to vertical incident light were measured using a device for measuring surface reflectance. The measurement of the reflectances of the SWS was performed at three different portions on the SWS (i.e., a central portion, a peripheral portion (a portion that is 10 mm apart from the central portion), and an intermediate portion between the central portion and the peripheral portion).

As shown in FIG. 10(A), the reflectance of the black resin substrate where no SWS is formed with respect to visible light was about 5 to 6%, whereas as shown in FIG. 10(B), the reflectance of the SWS with respect to visible light is reduced to about 0.09% or less.

### Third Example

In forming a concave and convex surface object according to the third example, polyester acrylate (polyfunctional) as the organic material in which ZnO fine particles as the inorganic fine particles were dispersed was used as the mixed material. In the mixed material, 20 weight % ZnO fine particles and 3 weight % dispersant were contained with respect to the whole weight. The particle diameter d50 of the ZnO fine particles was 8 nm, and the particle diameter d90 was 15 nm.

This mixed material was applied to the surface of the glass substrate by dipping, and thereafter cured by UV irradiation, thereby forming a mixture layer.

After that, the mixture layer was subjected to UV irradiation. Specifically, the UV irradiation was performed for 16 hours by a low-pressure mercury lamp, using a desktop-type light surface processing unit manufactured by SEN LIGHTS CORPORATION.

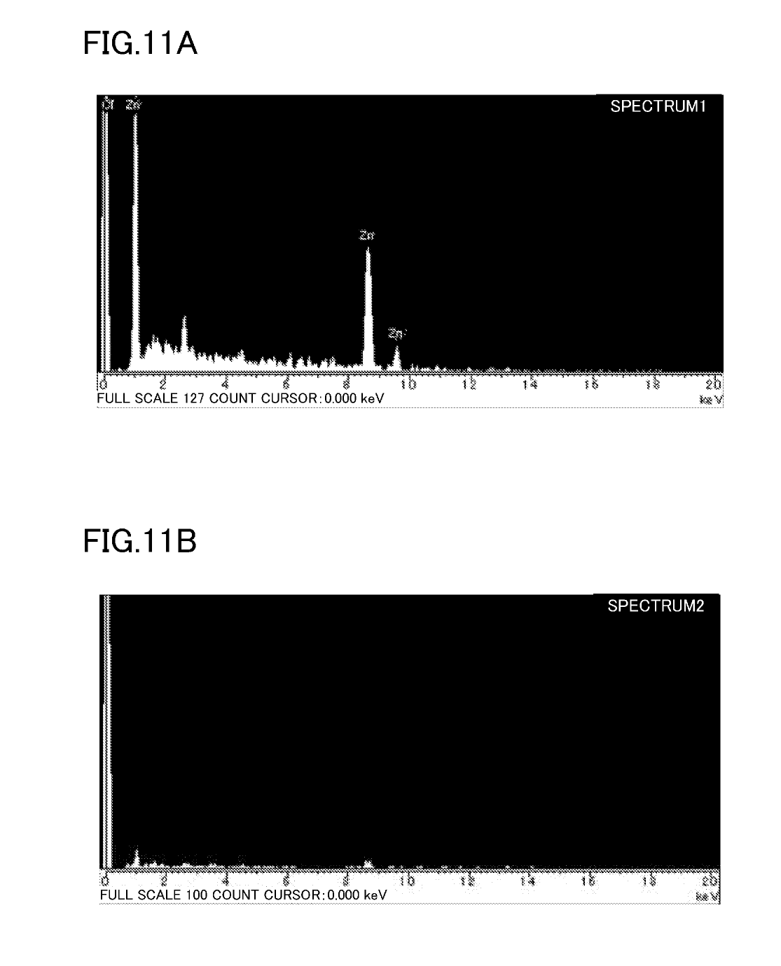

FIGS. 11(A) and 11(B) show results of measurement of surface compositions of the concave and convex surface object by EDX. FIG. 11(A) shows a surface composition of the concave and convex structure. FIG. 11(B) shows a surface composition of the base.

As shown in FIG. 11(A), the convex portions exhibit high peaks at around 1 keV and at around 8.6 keV. The peaks at around 1 keV and at around 8.6 keV indicate existence of Zn elements. That is, it is understood that the surface of the convex portion contains a lot of Zn elements. On the other hand, as shown in FIG. 11(B), although the base exhibits peaks at around 1 keV and at around 8.6 keV, those peaks are much lower than the peaks exhibited by the convex portions. It is understood that the base contains less Zn elements than the convex portion.

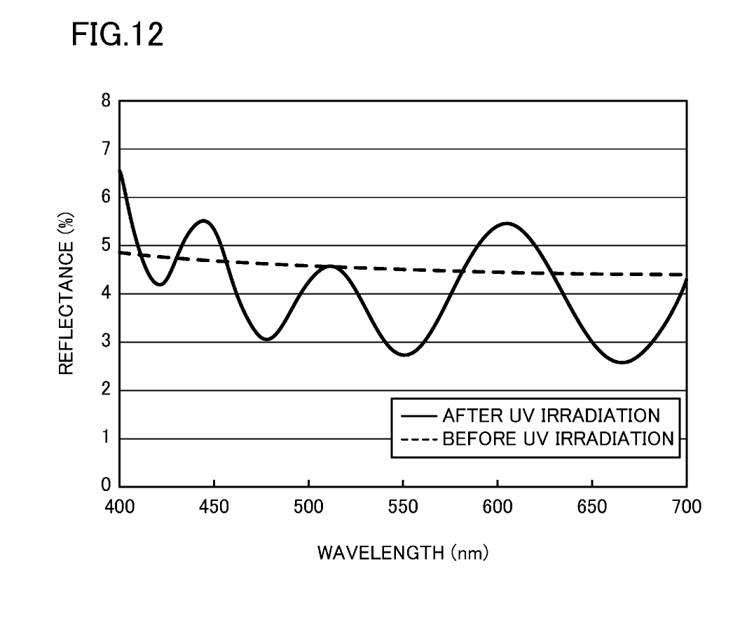

FIG. 12 shows results of measurement of reflectances of the SWS formed by the above method. Reflectances of vertically-reflected light with respect to vertical incident light were measured using a device for measuring surface reflectance. Reflectances (broken line in the drawing) of the mixture layer before the UV irradiation, and reflectances (solid line in the drawing) of the mixture layer after the UV irradiation were measured.

As shown in FIG. 12, the reflectances were uniform with respect to light in a wide range of wavelengths before the UV irradiation, whereas the reflectances significantly vary according to wavelength after the UV irradiation.

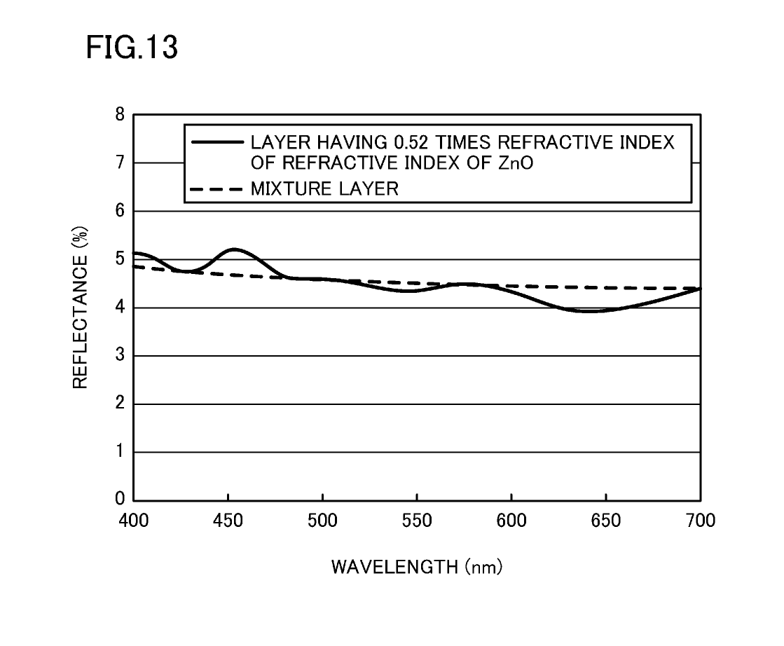

FIG. 13 shows results of simulation of reflectances of the surface of a mixture layer which has the same composition as that of the above mixture layer. The broken line in the drawing shows reflectances of the mixture layer which has the same composition as that of the above mixture layer and whose surface is flat. These reflectances correspond to the reflectances of the mixture layer before UV irradiation. On the other hand, the solid line in the drawing shows reflectances of the base surface on which a layer having a flat surface, having a refractive index that is 0.52 times of the refractive index of ZnO, and having a thickness of 950 nm is formed. The variation of the reflectances of this layer according to wavelength is similar to the variation of the reflectances of the mixture layer after the UV irradiation shown in FIG. 12. In other words, the mixture layer after the UV irradiation has the reflectances equivalent to those of the base on which the layer having a flat surface, having a refractive index that is 0.52 times of the refractive index of ZnO, and having a thickness of 950 nm is formed. This means that although the organic material is selectively decomposed and removed and the number of ZnO fine particles is increased in the mixture layer after the UV irradiation, the surface of the mixture layer is not a flat plane where the ZnO fine particles are uniformly dispersed, but a plane where the ZnO fine particles and air coexist, that is, a plurality of convex portions made of the ZnO fine particles are distributed. From this it is understood that it is possible to selectively remove the organic material and form a plurality of convex portions made of inorganic fine particles, also by performing the UV irradiation on the mixture layer.

As described above, the techniques disclosed herein are useful as concave and convex surface objects and methods of fabricating the concave and convex surface objects.

What is claimed is:

1. A concave and convex surface object having a concave and convex structure on its surface, wherein
the concave and convex structure has a base and a plurality of convex portions arranged on a surface of the base, and is made of a mixed material obtained by dispersing inorganic fine particles in an organic material,
an average refractive index of the concave and convex structure varies from a refractive index of air to a refractive index of the base, from a tip of each of the convex portions to the base, and
the inorganic fine particles exist more in a portion near a surface of each of the convex portions than in an inner portion of the convex portion.

2. The concave and convex surface object of claim 1, wherein
a reflectance of the concave and convex structure with respect to visible light is 1% or less.

3. The concave and convex surface object of claim 1, wherein
each of the convex portions has a height of 500 nm or more.

4. The concave and convex surface object of claim 1, wherein
the inorganic fine particles are agglomerated on a surface of each of the convex portions.

5. A concave and convex surface object having a concave and convex structure on its surface, wherein
the concave and convex structure has a base and a plurality of convex portions arranged on a surface of the base, and is made of a mixed material of inorganic fine particles and an organic material, and
a volume ratio of the inorganic fine particles in the convex portions is higher than a volume ratio of the inorganic fine particles in the base.

6. The concave and convex surface object of claim 5, wherein
a reflectance of the concave and convex structure with respect to visible light is 1% or less.

7. The concave and convex surface object of claim 5, wherein
each of the convex portions has a height of 500 nm or more.

8. The concave and convex surface object of claim 5, wherein
the inorganic fine particles are agglomerated on a surface of each of the convex portions.

9. A method of fabricating a concave and convex surface object having a concave and convex structure on its surface, wherein the method includes the steps of:
forming a mixture layer made of a mixed material obtained by dispersing inorganic fine particles in an organic material; and
selectively removing the organic material in the mixture layer, thereby forming a base and a plurality of convex portions of which an average refractive index varies from a refractive index of air to a refractive index of the base, from a tip of each of the convex portions to the base, and making each of the convex portions contain the inorganic fine particles more in a portion near a surface of each of the convex portions than in a portion near the base.
